(19) United States
(12) Patent Application Publication
(10) Pub. No.: US 2005/0061828 A1
(43) Pub. Date: Mar. 24, 2005

(54) Smoking product packaging device and method

(75) Inventor: Albert Benjamin Crogan, Lewiston, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Joseph M. Anderson

(21) Appl. No.: 10/663,118

(22) Filed: Sep. 15, 2003

(51) Int. Cl. B65H 3/00; G07F 11/16; B65G 59/00

(52) U.S. Cl. 221/265

(57) ABSTRACT

An improved apparatus (15) for packaging smoking products comprising a loading carriage (16) configured and arranged to hold smoking products, a reservoir divider (18) separating the loading carriage into a first reservoir compartment (19) for units of a first type of smoking product (21) and a second reservoir compartment (20) for units of a second type of smoking product (22), a feeder (23) for guiding a preselected number of the units of smoking product to an ejection position (24) for packaging, a feed divider (25) separating the feeder into a first feed compartment (26) for units of the first type of smoking product and a second feed compartment (28) for units of the second type of smoking product, the first reservoir compartment communicating with the first feed compartment and the second reservoir compartment communicating with the second feed compartment, the divider and compartments configured and arranged to guide units of the first type of smoking product and units of the second type of smoking product to the ejection area such that units of both the first type of smoking product and second type of smoking product are positioned to be ejected as a group (29).

### TECHNICAL FIELD

The present invention relates generally to the field of packaging machines and, more particularly, to a packaging machine which provides for the packaging of at least two types of smoking product.

### BACKGROUND ART

Cigarette packaging machines are well known in the prior art. Such machines generally allow for a tray, carriage or hopper to be filled with cigarettes and placed on a feeding device. The cigarettes in the carriage are gravity fed into the feeding device, which funnels the cigarettes to an ejection area for packaging. Such a machine is shown in FIG. 8.

However, such machines are only adapted to package one type of smoking product, namely cigarettes, in a package and do not allow for the organized packaging of more than one type of smoking product in a standard cigarette pack. Due to a number of market forces, there is a need for packaging of cigarettes with other types of smoking products. Thus, it would be beneficial to provide a mechanism and a package in which multiple types of smoking products can be grouped in a single package. Such different types of smoking products might include conventional tobacco cigarettes, herbal cigarettes and/or little cigars.

### DISCLOSURE OF THE INVENTION

With parenthetical reference to the corresponding parts, portions or surfaces of the disclosed embodiment, merely for the purpose of illustration and not by way of limitation, the present invention provides an improved apparatus (15) for packaging smoking products comprising a loading carriage (16) configured and arranged to hold smoking products, a reservoir divider (18) separating the loading carriage into a first reservoir compartment (19) for units of a first type of smoking product (21) and a second reservoir compartment (20) for units of a second type of smoking product (22), a feeder (23) for guiding a preselected number of the units of smoking product to an ejection position (24) for packaging, a feed divider (25) separating the feeder into a first feed compartment (26) for units of the first type of smoking product and a second feed compartment (28) for units of the second type of smoking product, the first reservoir compartment communicating with the first feed compartment and the second reservoir compartment communicating with the second feed compartment, the divider and compartments configured and arranged to guide units of the first type of smoking product and units of the second type of smoking product to the ejection area such that units of both the first type of smoking product and second type of smoking product are positioned to be ejected as a group (29). The first type of smoking product and the second type of smoking product may be selected from a group consisting of tobacco cigarettes, herbal cigarettes and cigars, and the cigars may be little cigars. The apparatus may further comprise a plugger for ejecting the group of units of the first and second smoking products.

The present invention also provides a method for packaging at least two types of smoking products into a single package (30) comprising the steps of providing the apparatus described above, filling the first compartment with units of the first type of smoking product, filling the second compartment with units of the second type of smoking product, feeding the units into the feeder, ejecting a preselected number of the units of both the first smoking product and second smoking product as a group, and wrapping the group in a single package.

The present invention also provides a package of smoking products comprising at least one unit of a first type of smoking product, at least one unit of a second type of smoking product, and a package enclosing the units of both the first and second smoking products. The first type of smoking product and second type of smoking product may be selected from a group consisting of tobacco cigarettes, herbal cigarettes and cigars. The package maybe a conventional cigarette pack configured to hold twenty units of a tobacco cigarette and the package may hold ten units of the first smoking product and ten units of the second smoking product.

Accordingly, the general object of the present invention is to provide an apparatus and method for packaging two types of smoking product in a single package.

Another object is to provide an apparatus and method allowing for greater versatility in the types of smoking products packaged in a single pack.

Another object is to provide an apparatus and method allowing for packaging of higher taxed smoking products with lower taxed smoking products in a single package.

Another object is to provide an apparatus and method for packaging two types of smoking products in a conventional cigarette package.

Another object is to provide a retrofitting solution for packaging two types of smoking products in a conventional cigarette package.

Another object is to provide a conventional cigarette package that contains two different types of smoking products.

These and other objects and advantages will become apparent from the foregoing and ongoing written specification, the drawing, and the appended claims.

### BRIEF DESCRIPTION OF THE DRAWINGS

FIG. 1 is a prospective view of the improved smoking product packaging apparatus.

FIG. 2 is a prospective view of the loading carriage shown in FIG. 1.

FIG. 3 is a prospective view of the feeder shown in FIG. 1.

FIG. 4 is a front elevation of the apparatus shown in FIG. 1 loaded with two different types of smoking products.

FIG. 5 is an exploded detailed view of the ejection area shown in FIG. 4.

FIG. 6 is a prospective view of the improved package of smoking products.

FIG. 7 is an exploded detailed view of the bottom portion of the reservoir divider shown in FIG. 1.

FIG. 8 is a prospective view of a cigarette packaging apparatus known to the prior art.

### DESCRIPTION OF THE PREFERRED EMBODIMENTS

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

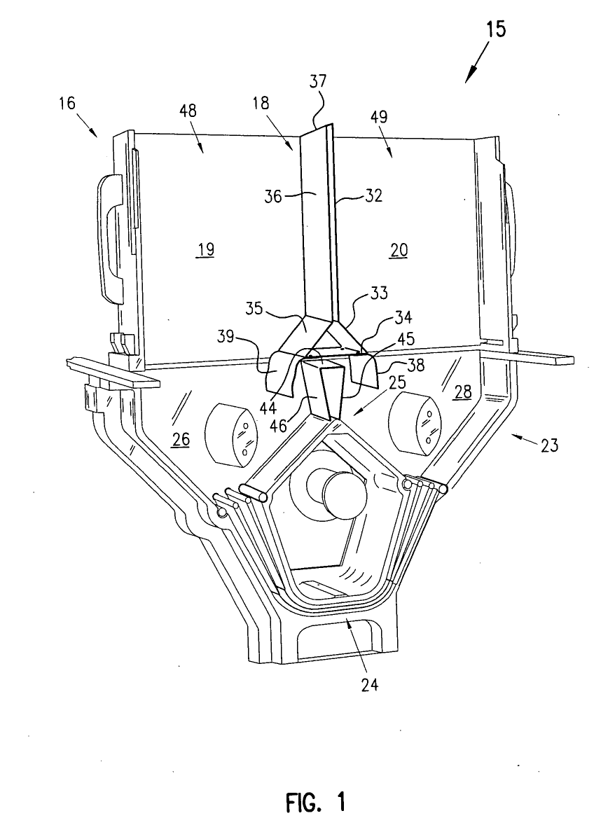

Referring now to the drawings and, more particularly, to FIG. 1 thereof, this invention provides an improved apparatus for packaging smoking products, of which the presently preferred embodiment is generally indicated at 15. In this embodiment, apparatus 15 generally includes a carriage 16 positioned above and in communication with a feeder 23.

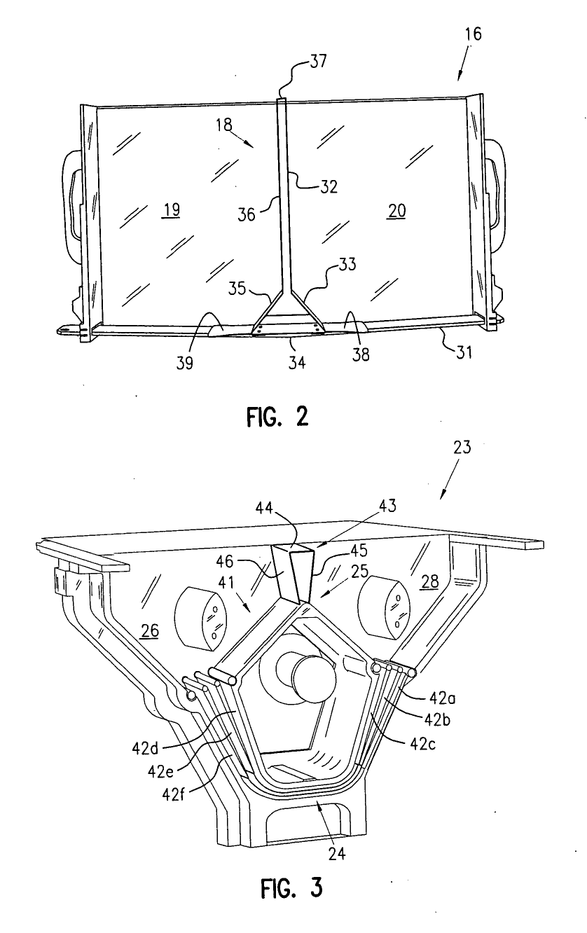

As shown in FIG. 2, carriage 16 is a container that is open on the top and on the front face and into which smoking products may be orderly arranged in layers. Carriage 16 is adapted to be mounted directly above feeder 23. Carriage 16 is equipped with a removable shutter 31 onto which smoking products are stacked. Shutter 31 is slidably positioned between the bottom of carriage 16 and the top of feeder 23 to control the flow of cigarettes from carriage 16 into feeder 23. Carriage 16 is filled with smoking products and, when positioned above feeder 23, shutter 31 is withdrawn rapidly and the smoking products from carriage 16 fall into feeder 23 under the influence of gravity.

As shown in FIGS. 1-2, carriage 16 is divided vertically in half by a divider 18. Divider 18 splits the containment space of carriage 16 entirely into a first compartment 19 and a second compartment 20. Divider 18 is defined by a rightwardly facing vertical planar surface 32, a rightwardly and upwardly facing sloped planar surface 33, a downwardly facing horizontal planar surface 34, a leftwardly and upwardly facing sloped planar surface 35, a leftwardly facing vertical planar surface 36 and an upwardly facing horizontal planar surface 37 joined at its right marginal edge to the top marginal edge of surface 32. In the preferred embodiment, divider 18 is welded in place.

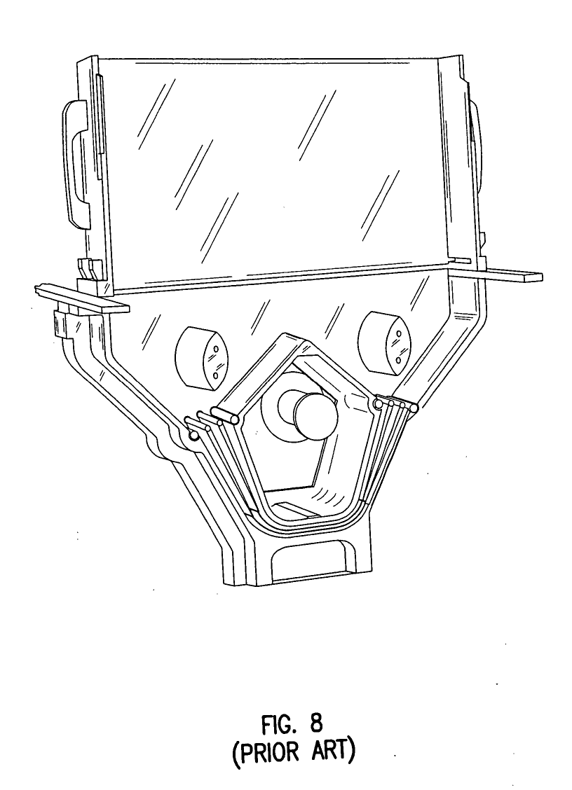

Divider 18 also includes a right flap 38 and a left flap 39 formed of a malleable material. FIG. 7 shows the means for holding right flap 38 in place. As shown, the left edge of flap 38 is positioned between surface 34 and a retaining plate 40, which is bolted to surface 34 such that right flap 38 is squeezed between the right portion of surface 34 and the top surface of retaining plate 40. Two bolts are employed in the preferred embodiment. Opposing left flap 39 is held in place in the same manner. Right flap 38 and left flap 39 provide additional dividing surfaces.

As shown in FIG. 3, feeder 23 is adapted to receive smoking product from carriage 16 and has two feed paths that feed into three opposing inclined passageways 42a-42f, such passageways having their lower ends in horizontal alignment with each other. As shown, feeder 23 has a feed divider 25 that splits the feeder entirely into two compartments 26 and 28. In the preferred embodiment, feed divider 25 includes a central guide member 41 and a guide insert 43. Guide insert 43 is defined by an upwardly facing horizontal planar surface 44, a rightwardly and downwardly facing sloped planar surface 45 and a leftwardly and downwardly facing sloped planar surface 46. The bottom marginal edges of surfaces 45 and 46 connect to the crown of guide member 41 near the top of the opposingly sloped surfaces of guide 41, respectively.

As shown in FIG. 1, carriage 16 is placed above feeder 23. When locked in place, dividers 18 and 25 split apparatus 15 into a left flow path 48 and right flow path 49. Left flow path 48 comprises compartment 19, compartment 26 and passageways 42d-42f. Right flow path 49 comprises compartment 20, compartment 28 and passageways 42a-42c.

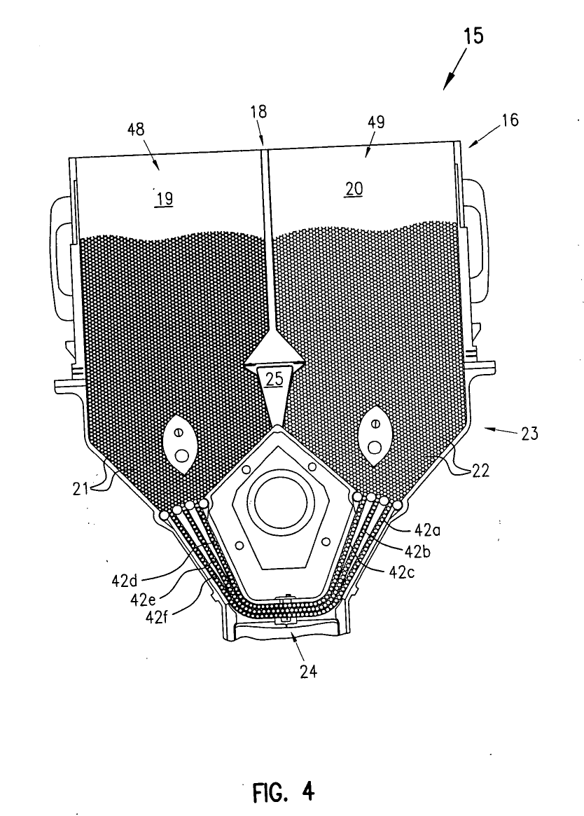

As shown in FIG. 4, this arrangement allows for apparatus 15 to be loaded with two different types of smoking product. In the preferred embodiment, the right side 49 of apparatus 15 is filled with conventional cigarettes 22. The left side 48 of apparatus 15 is filled with little cigars 21. Generally, a little cigar is rolled tobacco wrapped in leaf tobacco that weighs not more than three pounds per thousand. In the preferred embodiment, little cigars 21 are of a similar cross-sectional dimension to a cigarette. Compartment 20 of carriage 16 is filled with conventional cigarettes 22 and compartment 19 of carriage 16 is filled with little cigars 21. FIG. 4 shows apparatus 15 after removal of shutter 31, which allows the smoking products in compartments 19 and 20 of carriage 16 to fall by gravity into compartments 26 and 28 of feeder 23, respectively. Thus, conventional cigarettes 22 in compartment 20 of carriage 16 are directed by dividers 18 and 25 down the right side 49 of apparatus 15 into feed passageways 42a-42c. Similarly, little cigars 21 in compartment 19 of carriage 16 are directed down the left side 48 of apparatus 15 into feed passageways 42d-42f.

As shown in FIG. 2, flaps 38 and 39 rest against shutter 31 in a horizontal position. As shown in FIG. 4, when carriage 16 is placed on top of feeder 23 and shutter 31 is removed, the force of the smoking products in compartment 20 will bend right flap 28 down and against the sloping surface 45 of divider 25. Similarly, the smoking products in compartment 19 will force left flap 39 down against the sloping surface 46 of divider 25. In this manner, flaps 38 and 39 keep smoking product 21 and 22 from becoming trapped in or mixing through the space between bottom surface 34 of divider 18 and top surface 44 of divider 25.

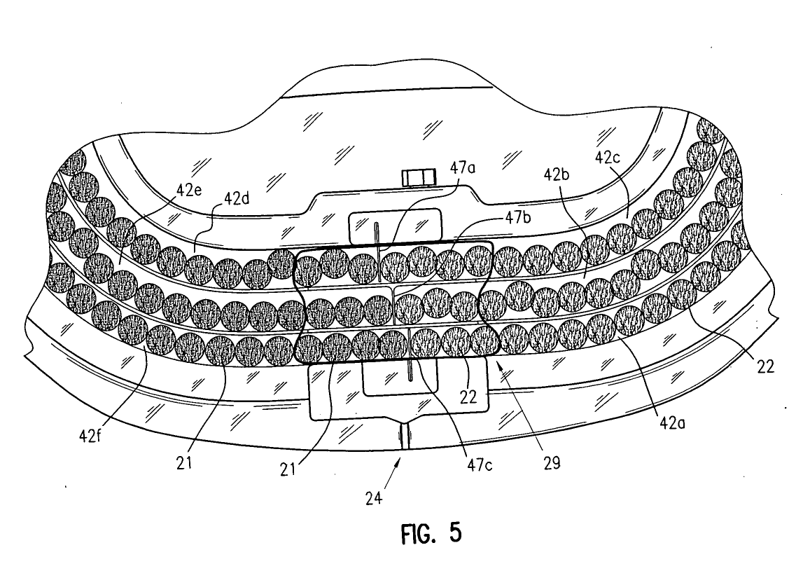

As shown in FIG. 5, passageways 42a-c feed conventional cigarettes 22 to ejecting position 29, and passageways 42d-f feed little cigars 21 to ejecting position 29, with passageways 42a-c supplying one-half of the required number of smoking products and passageways 42d-f supplying the other half of the required number of smoking products. Thus, the use of the device allows for ten units of conventional cigarettes 22 to be positioned in ejection area 29 and ten units of little cigars 21 to be positioned in ejection area 29 for ejection as a group of twenty units into a conventional pack. Stops 47a-c separate flow path 48 from flow path 49 at the bottom of the passageways. Thus, passageways 42a-f are provided with stops 47a-c against which on one side the leading units of cigarettes 22 in passageways 42a-c rest and against which on the opposing side the leading units of little cigars 21 in passageways 42d-f rest when a new group of smoking products are gravity fed into the ejection area 24 from the right 49 and left 48 side respectively. Once in position, ten units of cigarettes 22 and ten units of cigars 21 are ejected as a group by a conventional plunger at the same time into a receiving chamber where they are compressed into the proper shape for packaging in a single pack 30.

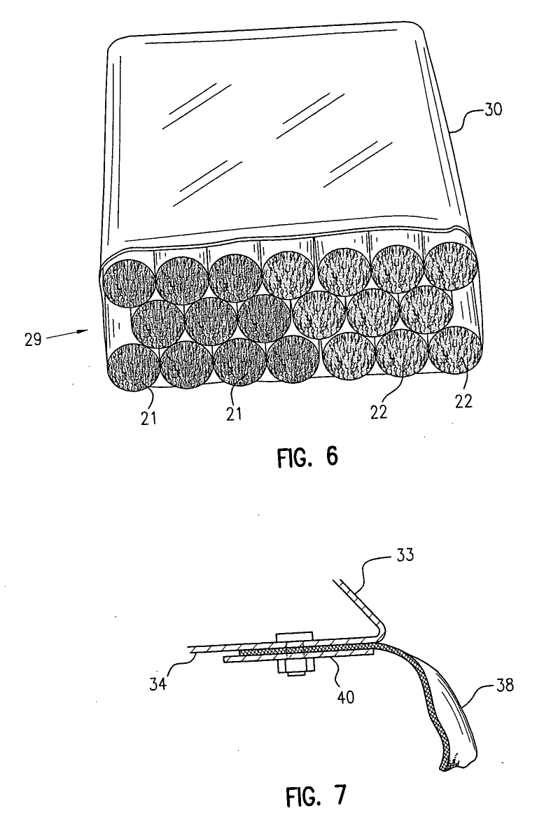

As shown in FIG. 6, in this manner a conventional or traditional cigarette pack 30 may be filled with two types of smoking products. In the preferred embodiment, the two types of smoking products are conventional cigarettes and little cigars and cigarette package 30 holds ten units of cigarettes 22 and ten units of little cigars 21 in three horizontal rows. The bottom row has four little cigars, fed from flow path 48, on the left and three cigarettes, fed from flow path 49, on the right. The second and middle row has three cigars, fed from flow path 48, on the left and three cigarettes, fed from flow path 49, on the right. The top row has three cigars, fed from flow path 48, on the left and four cigarettes, fed from flow path 49, on the right. The number of units of each product fed into package 30 is dependent on the placement of stops 47a-c and ejection area 29.

The present invention contemplates that many changes and modifications may be made. The specific type of material used maybe readily altered. In addition, various types of smoking products maybe employed, including without limitation conventional cigarettes, herbal cigarettes, small cigars and bidis. Therefore, while the presently-preferred form of the apparatus, method and package have been shown and described, and several modifications discussed, persons skilled in the art will readily appreciate that various additional changes and modifications may be made without departing from the spirit of the invention, as defined and differentiated by the following claims.

1. An apparatus for packaging smoking products comprising:
a loading carriage configured and arranged to hold smoking products;
a reservoir divider separating said loading carriage into a first reservoir compartment for units of a first type of smoking product and a second reservoir compartment for units of a second type of smoking product;
a feeder for guiding a preselected number of said units of said smoking products to an ejection position for packaging;
a feed divider separating said feeder into a first feed compartment for said units of said first type of smoking product and a second feed compartment for said units of said second type of smoking product;
said first reservoir compartment communicating with said first feed compartment and said second reservoir compartment communicating with said second feed compartment;
said dividers and compartments configured and arranged to guide units of said first type of smoking product and units of said second type of smoking product to said ejection area such that said units of both said first type of smoking product and said second type of smoking product are positioned to be ejected as a group.

2. The apparatus as set forth in claim 1, wherein said first type of smoking product and said second type of smoking product are selected from a group consisting of tobacco cigarettes, herbal cigarettes, and cigars.

3. The apparatus set forth in claim 2, wherein said cigars are little cigars.

4. The apparatus set forth in claim 1, and further comprising a plunger for ejecting said group of units of said first and second smoking product.

5. A method for packing at least two types of smoking products into a single package comprising the steps of:
providing the apparatus set forth in claim 1;
filling said first compartment with units of said first type of smoking product;
filling said second compartment with units of said second type of smoking product;
feeding said units into said feeder;
ejecting a preselected number of units of both said first smoking product and said second smoking product as a group; and
wrapping said group in a single package.

6. A package of smoking products comprising:
at least one unit of a first type of smoking product;
at least one unit of a second smoking product; and
a package enclosing said units of both said first and said second smoking product.

7. The package set forth in claim 6, wherein said first type of smoking product and said second type of smoking product are selected from a group consisting of tobacco cigarettes, herbal cigarettes and cigars.

8. The package set forth in claim 7, wherein said package is a conventional cigarette pack configured to hold twenty units of a conventional tobacco cigarette.

9. The package set forth in claim 8, wherein said package holds ten units of said first smoking product and ten units of said second smoking product.
